(19) United States
(12) Patent Application Publication
(10) Pub. No.: US 2011/0109074 A1
(43) Pub. Date: May 12, 2011

(54) BOOK PAGE HOLDER

(76) Inventor: Hee Jae Lee, Seoul (KR)

(21) Appl. No.: 13/003,074

(22) PCT Filed: Jul. 3, 2009
(86) PCT No.: PCT/KR09/03635

§ 371 Date: Jan. 11, 2011

(30) Foreign Application Priority Data
Jul. 8, 2008 (KR) 10-2008-0066245

(51) Int. Cl. B42D 9/00

(52) U.S. Cl. 281/42

(57) ABSTRACT

Disclosed is a book page holder interposed between pages of a book to prevent the current page from turning. The book page holder includes a body having a rod shape, and a page turning stopper formed on a surface of the body and having a concave outline to closely make contact with a binding part of the book.

### TECHNICAL FIELD

The present invention relates to a book page holder, and more particularly to a tool inserted between pages of a book to prevent the pages from being turned while a user is reading the book.

### BACKGROUND ART

In general, book holders help a user to smoothly read a book. For instance, types of book holders may include bookmarks or reading desks. A conventional bookmark is used to allow a user to mark a page of a book at which the user stops reading, so that the user can easily find the page through the bookmark when continuing to read the book at that page later. Meanwhile, a book desk is used to adjust the angle of the book to reduce the fatigue of the user's eyes and to increase the concentration of the user on the book when the user reads the book.

However, when a user reads a book in a transportation vehicle such as a train or a bus and not in a room in which a desk is placed, the user may feel it inconvenient to carry with him a book desk.

In addition, a book mark is interposed between specific pages of a book to mark only the pages that have already been read by the user.

However, if a user does not grip or press a spread book with his hands when reading the book, the page, which the user is reading, can turn and the next page naturally appear due to the binding characteristics of the book, so that the user must interrupt his reading to find again the page the was reading.

Accordingly, a tool is required to prevent a page, which a user is reading, from being turned without the user having to either forcibly press or grip the book while reading.

### DISCLOSURE

### Technical Problem

An object of the present invention is to provide a book page holder having a structure that prevents a page, which a user is reading, from being turned when the user reads a book.

### Technical Solution

According to the present invention, there is provided a book page holder interposed between pages of a book to prevent the current page from turning. The book page holder includes a body having a rod shape, and a page turning stopper formed on a surface of the body and having a concave outline to closely make contact with the binding part of the book.

Preferably, the book page holder further includes a book mark protruding out of the body with a long length.

Preferably, the book mark is made of a polymer material having flexibility.

Preferably, a pair of page turning stoppers are provided to closely make contact with two facing pages, and are attached to a polymer material having an adsorption property.

Preferably, the body and the book mark are detachably coupled with each other.

Preferably, the body includes an earplug receiving groove, and the earplug receiving groove receives an earplug such that the earplug is separated from the earplug receiving groove.

Preferably, the body includes a scratch pad part having an adhesion property and a cleaner to clean a glass surface.

Preferably, the body includes a small-size magnifying glass or a small-size lamp.

Preferably, the body includes a USB memory or a small-size rechargeable battery.

Preferably, the body is provided with a coupling groove fitted around a pencil or a ball point pen.

Preferably, the body includes a ring part linked with a key chain.

### Advantageous Effects

According to the book page holder of the present invention, the page turning stopper closely makes contact with a peripheral portion of the binding part of the book, so that the current page is prevented from turning. The page turning stopper can be used as a tool to turn a page if necessary. According to several embodiments of the present invention, various functions can be added and used.

### DESCRIPTION OF DRAWINGS

FIG. 1 is a perspective view showing a book page holder according to an exemplary embodiment of the present invention;

FIG. 2 is an exploded perspective view showing the book page holder shown in FIG. 1;

FIG. 3 is a view showing an example of the book page holder shown in FIG. 1;

FIG. 4 is an exploded perspective view showing a book page holder according to another embodiment of the present invention;

FIGS. 5 and 6 are exploded perspective views showing the book page holder according to still other embodiments of the present invention;

FIGS. 7 and 8 are views showing an example of the book page holder shown in FIG. 5; and

FIGS. 9 and 10 are views showing a book page holder according to still yet other embodiments of the present invention.

### BEST MODE

### Best Mode for Practicing the Invention

Hereinafter, exemplary embodiments of the present invention will be described with reference to the accompanying drawings.

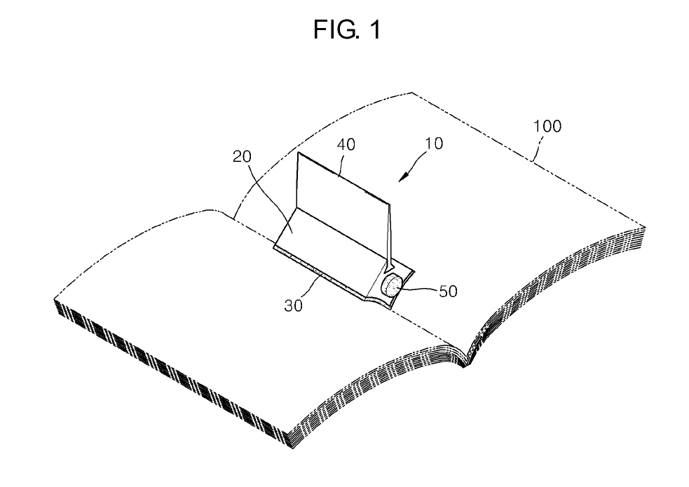

FIG. 1 is a perspective view showing a book page holder 10 according to an exemplary embodiment of the present invention.

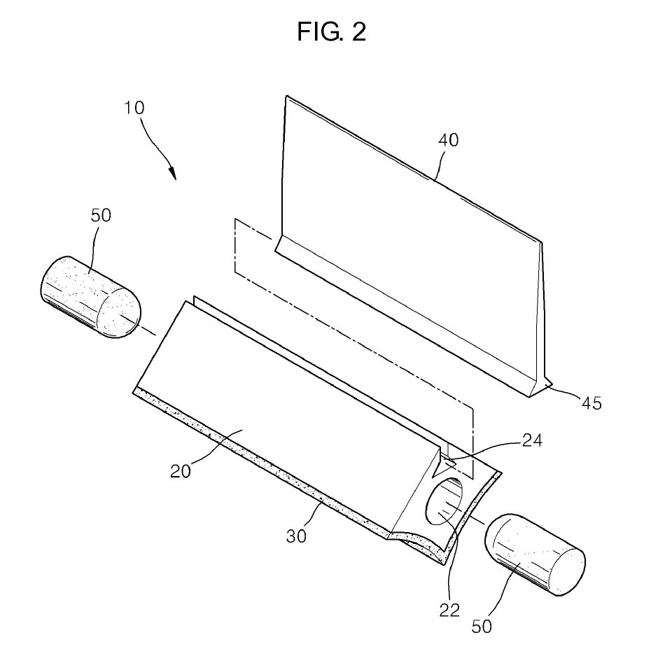

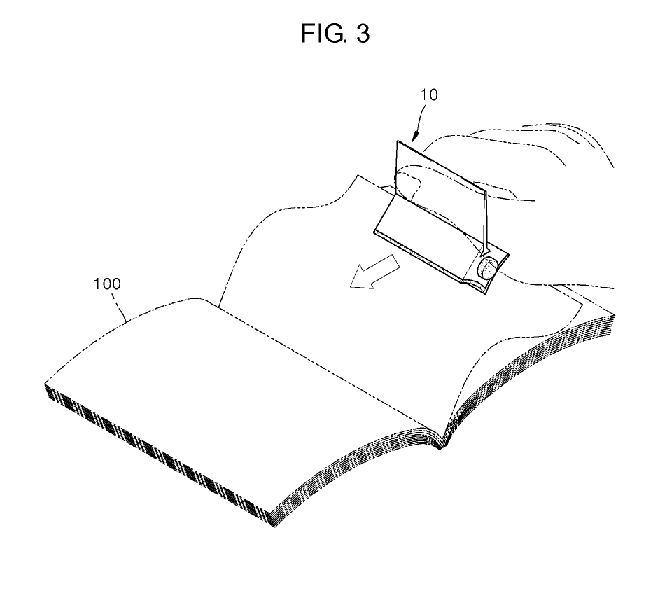

FIG. 2 is an exploded perspective view showing the book page holder shown in FIG. 1. FIG. 3 is a view showing an example of the book page holder of FIG. 1.

Referring to FIGS. 1 to 3, the book page holder 10 according to an exemplary embodiment of the present invention is inserted between pages of a book to prevent the current page from being turned so that the next page appears. The book page holder 10 includes a body 20, a page turning stopper 30, a book mark 40, and an earplug 50.

The body 20 has a rod shape. The body 20 may be made of various materials such as metal, plastic, and wood. The body 20 includes the page turning stopper 30, earplug receiving grooves 22, and a guide groove 24. The page turning stopper 30 is recessed inward from the surface of the body 20. According to the present embodiment, a pair of the page turning stoppers 30 are provided. Preferably, the page turning stoppers 30 have a shape corresponding to the shape of the part of a book near the binding part of the book such that the page turning stoppers 30 closely make contact with the part near the binding part of the book. The page turning stoppers 30 are attached to a pad made of a polymer having an adsorption property. The pad allows the page turning stopper 30 to smoothly make contact with pages facing each other. Preferably, the pad is made of polymer material, such as rubber or silicon, having an adsorption property. The earplug receiving grooves 22 are provided at both sides of the body 20. The earplug receiving grooves 22 are recessed inward from the body 20 and have a receiving space. The guide groove 24 extends in a longitudinal direction of the body 20. The guide groove 24 is coupled with the book mark 40 to be described later.

The earplug 50 is detachably received in the earplug receiving groove 22. When a user reads a book in a noisy environment such as in a subway, the ear plug 50 is separated from the earplug receiving grooves 22 and put into user's ears to prevent the noisy environment from interrupting the reading of the user, so that the user can concentrate on the book.

Similarly to a conventional book mark, the book mark 40 is interposed between pages of a book so that a user can later easily find the page at which the user stops reading. The book mark 40 protrudes out of the body 20 with a long length. The book mark 40 includes a guide rail 45. The guide rail 45 is fitted into the guide groove 24 provided in the body 20, so that the book mark 40 can be detachably coupled with the body 20. Preferably, the book mark 40 is made of rubber having flexibility like silicon. For instance, the book mark 40 may be made of rubber, silicon, or PVC. The book mark 40 is made of a material having flexibility to prevent pages from being scarred or defected. In addition, the bookmark 40 may be made of rubber having flexibility so that friction between the book mark 40 and the paper surface of the page may be greater than friction between a user's finger and the paper surface of the page. The bookmark 40 has a thickness that gradually becomes thinner as the book mark 40 extends away from the body 20.

Hereinafter, the operation of the book page holder 10 having the above structure according to the present embodiment will be described in detail.

Referring to FIG. 1, a user may read a specific page of a book. As shown in FIG. 1, the page turning stopper 30 of the body 20 closely makes contact with the surfaces of both pages near the binding part of the book. The page turning stopper 30 closely makes contact with the surfaces of the pages of the book while matching with the outline of the surfaces of the pages of the book. In this state, if there is a tendency for the current page to turn so that the next page appears, the page turning stopper 30 presses the surfaces of the pages, thereby preventing the current page from turning. As described above, the page turning stopper 30 is inserted near the binding part of the book so that the current page is prevented from being turned. Accordingly, it is unnecessary for a user to act to prevent the page from being turned by using hands, arms, or other objects. Therefore, the user can freely use both hands, so that the user can record notes and concentrate on the reading of the book. In addition, the book page holder 10 can be used as a tool to turn over the page. This use can be easily recognized from FIG. 3. As shown in FIG. 3, a user grips the book mark 40 with fingers, allows the book mark 40 to make contact with the edge of a page to be turned, and slightly applies force to the page in the direction in which the page is turned. In this case, only the current page is turned due to the frictional force between the page turning stopper 30 and the surface of the page so that a next page appears. In addition, when a user reads a book in a noisy environment, the earplug 50 prevents noise from interrupting the reading of the user, so that the user can concentrate on the reading of the book.

The book page holder according to the present invention may have various modifications, and, hereinafter, several modifications will be described below with reference to the accompanying drawings.

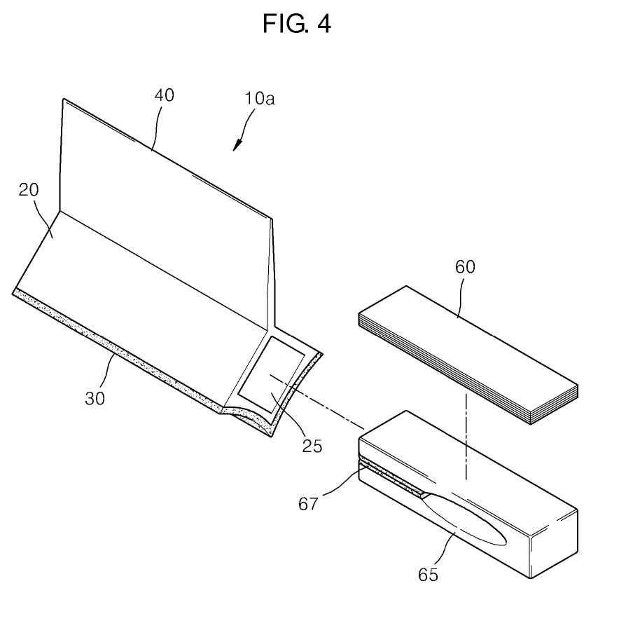

FIG. 4 is an exploded perspective view showing a book page holder 10a according to another embodiment of the present invention. Referring to FIG. 4, the book page holder 10a according to the present invention has the same structure as that of the embodiment described with reference to FIGS. 1 to 3 in that the book page holder 10a includes the body 20, the page turning stopper 30, and the book mark 40. The book page holder 10a includes the receiving space 25 passing through the internal part of the body 20 in the longitudinal direction of the body 20. As shown in FIG. 4, the receiving space 25 receives a scratch paper part 60 and a cleaner 65 in such a manner that the scratch paper part 60 and the cleaner 65 can be separated from the receiving space 25. The scratch paper part 60 includes a plurality of scratch papers having an adhesion property and overlapping with each other in several layers. The scratch paper part 60 representatively includes a post-it note. The scratch paper part 60 allows a reader to record an important matter or a simple matter thereon when reading the book. The cleaner 65 has the form of pincers having one side portion including nonwoven fabric or micro-fiber used to clean a glass surface, a magnifying glass, or a screen.

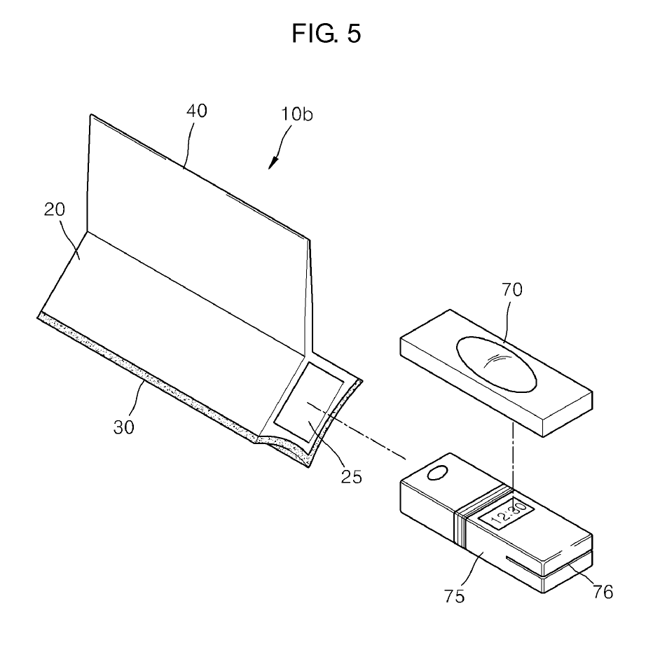

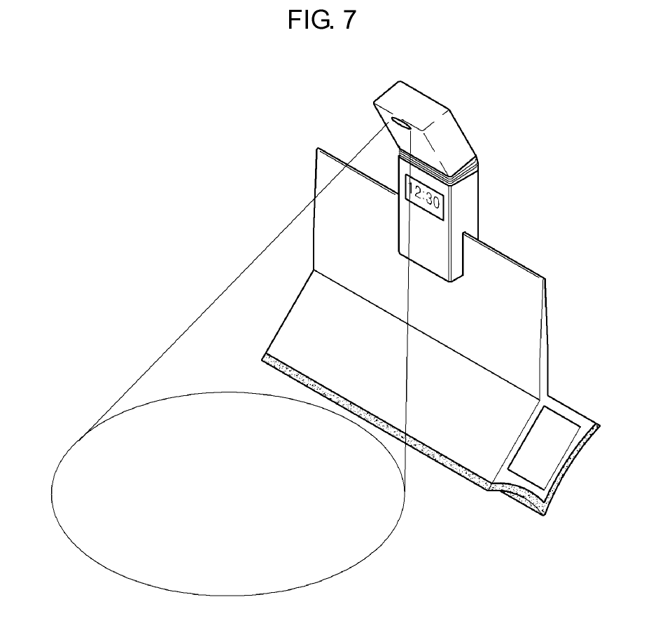

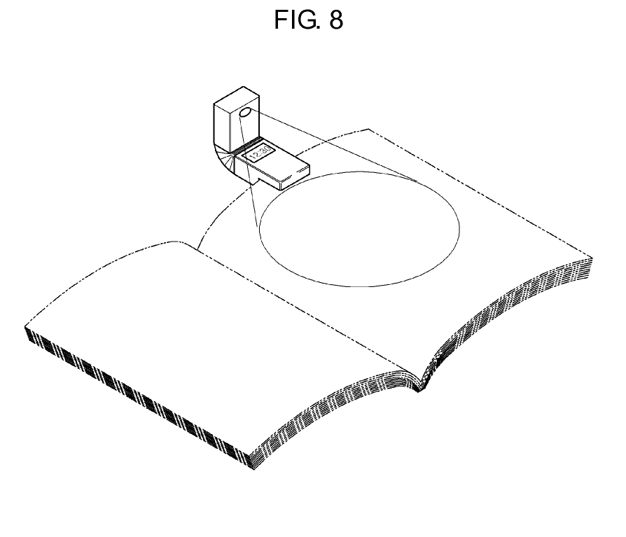

Referring to FIG. 5, the book page holder 10b shown in FIG. 5 has the same structure as that shown in FIG. 4 except that the receiving space 25 of the book page holder 10b receives a different component. The receiving space 25 of the book page holder 10b includes a small-size magnifying glass 70 and a small-size lamp 75. As shown in FIG. 5, the small-size magnifying glass 70 has the form of a flat frame provided at the central portion thereof with a through hole in which a convex lens is provided. The small-size lamp 75 includes a light source part, which may be folded as shown in FIGS. 5, 7, and 8, and a slit 76 fixedly fitted around the page of the book or the book mark 40. The small-size lamp 75 is provided to allow a user to conveniently read a book in a place where lighting facilities are not provided without exerting a bad influence on peripheral people. Since the small-size lamp 75 includes a digital clock, a reader can check the time while reading.

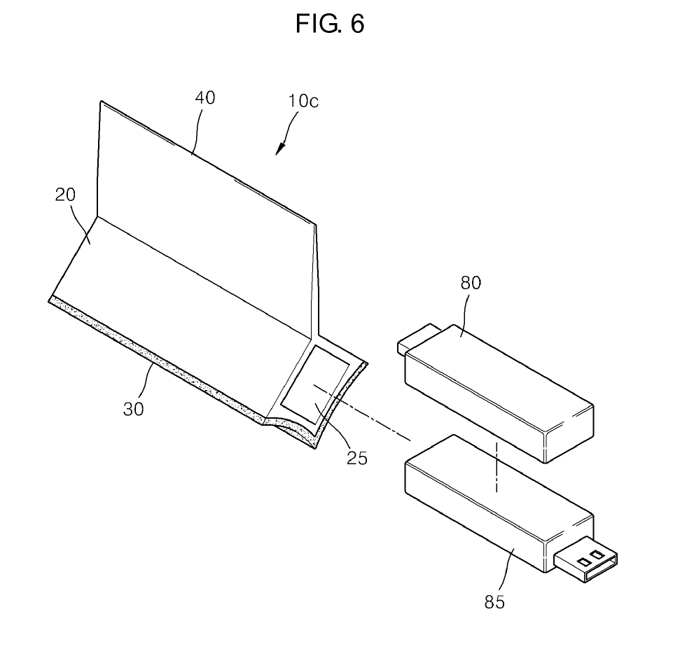

Referring to FIG. 6, the book page holder 10c shown in FIG. 6 has the same structure as that of FIGS. 4 and 5 except that a different component is received in the receiving space 25. Referring to FIG. 6, the receiving space 25 may include a USB memory 85 or a small-size rechargeable battery 80. The rechargeable battery 80 and the USB memory 85 may be integrated with each other or may be separately received in the receiving space 25. The rechargeable battery 80 or the USB memory 85 may be carried by a user and used to supply power to a portable electronic appliance such as a cellular phone or a PMP or a spare memory unit.

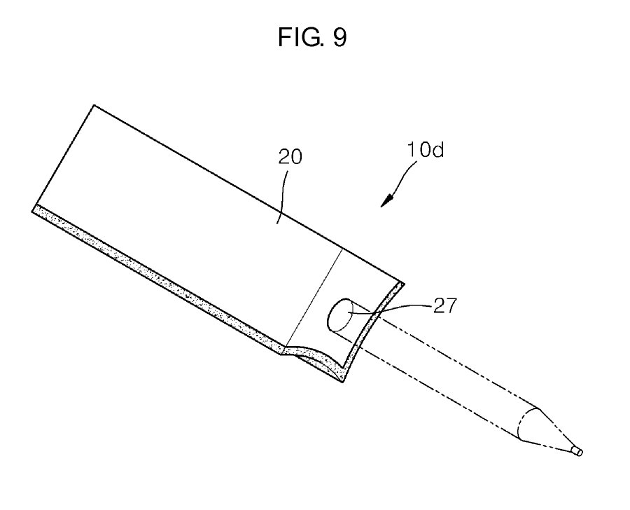

Referring to FIG. 9, the book page holder 10e according to the present invention has a characteristic in that the body 20 includes a coupling groove 27 fitted around a pencil or a ball point pen. The coupling groove 27 may be easily installed in a pencil case by students so that the loss possibility of the book page holder 10e can be reduced.

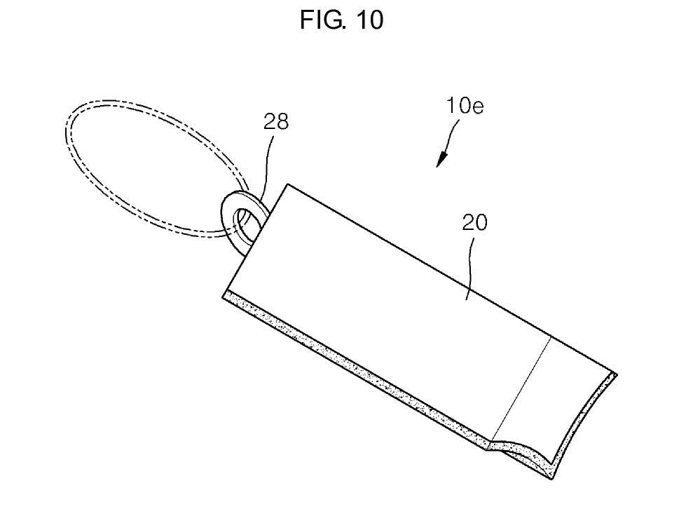

Referring to FIG. 10, the book page holder 10e according to the present invention includes the body 20 having a ring part 28 that can be liked with a key chain, so that the book page holder 10e can be easily carried with a key chain or a cellular phone. Accordingly, the user can use the book page holder 10e regardless of location and time, and the loss possibility of the book page holder 10e can be reduced.

The embodiment of the present invention has been described in that the book page holder includes a book mark protruding out of the body. However, even if the book mark is not provided, the object of the present invention can be sufficiently achieved.

The embodiment of the present invention has been described in that the bookmark is made of polymer material having flexibility. However, even if the book mark is made of rigid plastic or metal such as polypropylene instead of the polymer material having flexibility, the object of the present invention can be sufficiently achieved.

The embodiment of the present invention has been described in that a pair of page turning stoppers make contact with two facing pages, and are made of polymer material having an adsorption property. Even if the page turning stoppers are not attached to the polymer material having the adsorption property so that the adsorption effect may be degraded more or less, the object of the present invention can be sufficiently achieved.

The embodiment of the present invention has been described in that the body and the book mark are detachably coupled with each other. However, even if the body is integrated with the book mark, the object of the present invention can be achieved.

The embodiment of the present invention has been described in that the book page holder includes an earplug, scratch paper, a cleaner, a magnifying glass, a lamp, a rechargeable battery, and a USB memory. However, even if the book page holder does not include the above components, the object of the present invention can be achieved. Even if the body includes different components that are not listed above, the object of the present invention can be achieved.

Although exemplary embodiments of the present invention have been described, it is understood that the present invention should not be limited to these exemplary embodiments but various changes and modifications can be made by one with ordinary skill in the art within the spirit and scope of the present invention as hereinafter claimed.

1. A book page holder interposed between pages of a book to prevent the current page from turning, the book page holder comprising:
a body having a rod shape; and
a page turning stopper formed on a surface of the body and having a concave outline to closely make contact with a binding part of the book.

2. The book page holder of claim 1, further comprising a book mark protruding out of the body with a long length.

3. The book page holder of claim 2, wherein the book mark is comprised of a polymer material having flexibility.

4. The book page holder of claim 1, wherein a pair of the page turning stoppers are provided to closely make contact with two facing pages, and are attached to a polymer material having an adsorption property.

5. The book page holder of claim 2, wherein the body and the book mark are detachably coupled with each other.

6. The book page holder of claim 1, wherein the body includes an earplug receiving groove, and the earplug receiving groove receives an earplug such that the earplug is separated from the earplug receiving groove.

7. The book page holder of claim 1, wherein the body includes a scratch pad part having an adhesion property and a cleaner to clean a glass surface.

8. The book page holder of claim 1, wherein the body includes a small-size magnifying glass or a small-size lamp.

9. The book page holder of claim 1, wherein the body includes a USB memory or a small-size rechargeable battery.

10. The book page holder of claim 1, wherein the body is provided therein with a coupling groove fitted around a pencil or a ball point pen.

11. The book page holder of claim 1, wherein the body includes a ring part linked with a key chain.
